(19) United States
(12) Patent Application Publication
(10) Pub. No.: US 2023/0390671 A1
(43) Pub. Date: Dec. 7, 2023

(54) PORTABLE SETTLING TANK CONFIGURED FOR USE AS A SEDIMENT CONTROL WITH SLUDGE REMOVAL

(71) Applicant: MAZ CONTRACTING INC., Saxonburg, PA (US)

(72) Inventor: Michael A. Zock, Saxonburg, PA (US)

(21) Appl. No.: 18/205,717

(22) Filed: Jun. 5, 2023

Related U.S. Application Data
(63) Continuation of application No. PCT/US21/62082, filed on Dec. 6, 2021.
(60) Provisional application No. 63/121,311, filed on Dec. 4, 2020.

(51) Int. Cl. B01D 21/00; B01D 21/24; B01D 21/01

(52) U.S. Cl. CPC B01D 21/0051; B01D 21/245; B01D 21/0006; B01D 21/01

(57) ABSTRACT

A portable lamella settling tank is configured for use as a sediment trap. The tank includes a transportable housing having a settling tank portion; a fluid inlet within the housing; a fluid treatment station downstream of the inlet configured for fluid treatment additives to be introduced to incoming fluid; agitation piping downstream of the fluid treatment station configured to mix the fluid treatment additives and the incoming fluid; mixing wells downstream of the agitation piping and each having an outlet extending into the settling tank portion; a lamella separator having a spillway located within the center of the lamella separator above the height of the mixing well outlets, wherein the lamella separator is configured for operation with the housing up to at least 5% out of level in roll and pitch orientations; a fluid outlet coupled to the spillway; and a sludge takeout for removal of sludge.

### RELATED APPLICATIONS

This application is a continuation of International Patent Application Serial Number PCT/US2021/062082 filed Dec. 6, 2021 and titled “Portable Settling Tank Configured for Use as a Sediment Control” which published Jun. 9, 2022 as WO 2022/120293. International Patent Application Serial Number PCT/US2021/062082 claims priority to U.S. provisional patent application Ser. No. 63/121,311 filed Dec. 4, 2020, titled “Portable Settling Tank Configured for Use as a Sediment Control.” The above identified applications and publications are incorporated herein by reference in its entirety.

### BACKGROUND OF THE INVENTION

### Field of the Invention

The present invention relates to portable settling tanks, and more particularly to a sediment control in the form of a construction grade portable lamella sediment trap.

### Background Information

The U.S. Environmental Protection Agency (US EPA) has determined that water runoff from construction sites is by far the largest source of sediment in urban areas under development. The U.S. EPA cites studies from at least as early as 1988 which have concluded that unabated soil erosion removes over 90 percent of sediment by tonnage in urbanizing areas where most construction activities occur. For comparison, erosion rates from natural areas such as undisturbed forested lands are typically less than one ton/acre/year, while unabated erosion from construction sites ranges from 7.2 to over 1,000 tons/acre/year.

Eroded sediment from construction sites creates many problems including adverse impacts on water quality, critical habitats, submerged aquatic vegetation beds, recreational activities, and navigation. As an illustrative example, the US EPA details that the Miami River in Florida has been severely affected by pollution associated with upland erosion. The watershed associated with the Miami River has undergone extensive urbanization, which has included the construction of many commercial and residential buildings over the past ¾ century, with most construction occurring in the last ½ century. Sediment deposited in the Miami River channel contributes to the severe water quality and navigation problems of this once-thriving waterway, as well as Biscayne Bay.

Sediment controls capture sediment that is transported in runoff. Filtration and detention (gravitational settling) are the main processes used to remove sediment from runoff. Sediment controls have been described by the Ohio EPA, and others, as representing the compromise between protecting water resources and accomplishing work during grading and construction activities. Construction activities underway when intense storms happen have been shown to yield significantly greater amounts of mud or sediment than other land disturbing activities, such as agricultural crop production. Eventually disturbed soils will be stabilized with new vegetation, landscaping and buildings, but in the interim practices that are effective in capturing sediment are needed to prevent tons of soil from moving offsite and into wetlands, ponds, lakes, creeks and rivers. Sediment controls are a compromise, because they don't capture all sediment. They capture the largest soil particles, (sands and large silts), but are not very effective with smaller silts and clay particles. Additionally, not all practices are equally effective. Settling ponds may be greater than 80 percent effective, if designed and operated properly. Other practices, like inlet protection or silt fences are some times less than 50 percent effective, even if installed and maintained properly. Further in a settling pond, effectiveness also depends on the size of eroded particles entering the pond. For example, if suspended particles are fine silts and clays, then the effectiveness of capture decreases. Conversely, if eroded particles are large silts and sands, then effectiveness will increase with the same pond design. Thus, site designers must combine a strategy of phasing, construction, and rapid stabilization with the most effective sediment control practices that can be used on their site.

Sediment basins, also known as silt basins, are engineered impoundment structures that allow sediment to settle out of the runoff. They are installed prior to full-scale grading and remain in place until the disturbed portions of the drainage area are fully stabilized. They are generally located at the low point of sites, away from construction traffic, where they will be able to trap sediment-laden runoff. Sediment basins are typically used for drainage areas between 5 and 100 acres. They can be classified as either temporary or permanent structures, depending on the length of service of the structure. If they are designed to function for less than 36 months, they are generally classified as “temporary”; otherwise, they are considered permanent structures. Temporary sediment basins can also be converted into permanent runoff management ponds. When sediment basins are designed as permanent structures, they must meet the standards for wet ponds.

Sediment traps are often temporary and usually decommissioned after the disturbed area is stabilized (i.e., with vegetation or other cover). A temporary sediment trap is generally only be used in a location with a drainage area of five (5) acres or less and where it will be used for two years or less. However, in sites that may be suitable for a temporary sediment trap there may be insufficient space to locate the sediment trap and/or factors preventing the construction of the necessary structure in the ground.

Portable sediment traps, also called portable sediment tanks, generally in the form of compartmented tanks have been proposed but have been somewhat commercially unviable to date. The New York Department of Environmental Conservation defines that a sediment tank is a compartmented tank container to which sediment laden water is pumped to trap and retain the sediment. The stated purpose of the sediment tank is to trap and retain sediment prior to pumping the water to drainage-ways, adjoining properties, and rights-of-way below the sediment tank site. The New York Department of Environmental Conservation states that a sediment tank is to be used on sites where excavations are deep, and space is limited, such as urban construction, where direct discharge of sediment laden water to stream and storm drainage systems is to be avoided. The New York Department of Environmental Conservation further states that a sediment tank shall be located for ease of clean-out and disposal of the trapped sediment, and to minimize the interference with construction activities and with pedestrian traffic.

Another commercially available portable sediment trap is in the form of a roll off container, or similar structure, with a filter media across the top or a filter bag within the roll off container. These devices are sometimes referenced as “sludge boxes.”

The phrase “sedimentation tank”, also called “settling tank” or clarifier, defines a volumetric area, known as the tank, which is configured to allow suspended particles to settle out of fluid, such as commonly wastewater, as it flows slowly through the tank, thereby providing some degree of purification. A layer of accumulated solids forms at the bottom or top of the tank. Accumulated solids at the bottom of the tank are often called sludge is periodically removed.

The present invention relates to sedimentation tanks or settling tanks and the phrase “settling tank” or “sedimentation tank” will be used herein to define a tank holding liquid suspension therein until at least some of particles suspended within the liquid settles out. The present invention is designed for sediment control but has broader application than sediment controls (e.g. for use by a local water or sanitary authority for water treatment after a flood). The phrase “sediment trap” will reference herein a settlement tank, or sedimentation tank, which is configured to capture sediment that is transported in land based water runoff. Finally, it is noteworthy that the phrase “sedimentation tank” is somewhat more descriptive and accurate than the phrase “settling tank”, but the phrase “settling tank” is more easily distinguishable from the phrase “sediment trap” which has a more specific land based water runoff definition within this application.

Sediment basins and traps, including portable sediment traps, intercept and retain sediment-laden water runoff from a construction site for a sufficient period of time to allow the majority of sediment to settle out prior to being released from the site. Proper use of these structures can greatly reduce sediment transport off-site; if properly designed, installed, and maintained, sediment removal efficiency of greater than 80 percent can typically be achieved in many of these structures.

There remains a need for portable sediment traps that are efficient and cost effective, and for efficient and effective portable settling tanks, or sedimentation tanks, for general operations.

### SUMMARY OF THE INVENTION

One aspect of the present invention provides a portable lamella settling tank which comprises a transportable housing having a settling tank portion; a fluid inlet within the housing; mixing wells downstream of the fluid inlet and each having an outlet extending into the settling tank portion; a lamella separator having a spillway within the settling tank portion positioned above the height of the mixing well outlets, wherein the lamella separator is configured for operation with the housing up to at least 2% out of level in roll and pitch orientations; and a fluid outlet coupled to the spillway.

The present invention may be defined as a sedimentation tank comprising a portable housing having a settling tank portion; a fluid inlet within the housing; a weir within the settling tank portion configured for settling operations when the housing is level in the pitch and roll orientations or an out-of-level pitch and roll orientation of up to 10% in the pitch orientation or up to 15% in the roll orientation; and a fluid outlet coupled to the weir.

Another aspect of the invention provides a portable lamella settling tank including a transportable housing having a settling tank portion; a fluid inlet within the housing; at least one mixing well downstream of the fluid inlet and having an outlet extending into the settling tank portion; a lamella separator having a spillway within the settling tank portion positioned above the height of the mixing well outlet, wherein the spillway is located within the center of the lamella separator and wherein the lamella separator is configured for operation with the housing up to at least 5% out of level in roll and pitch orientations; a fluid outlet coupled to the spillway; and a sludge removal system for removal of sludge in the settling tank portion in form of at least one of i) a clean out door provided in the housing for batch operation mode or ii) sludge piping extending from a lower area of the settling tank portion for continuous operation mode.

Another aspect of the invention provides a portable lamella settling tank including a transportable housing having a settling tank portion; a fluid inlet within the housing; a fluid treatment station downstream of the inlet configured for fluid treatment additives to be introduced to incoming fluid; agitation piping downstream of the fluid treatment station configured to mix the fluid treatment additives and the incoming fluid; a pair of mixing wells downstream of the agitation piping and each having an outlet extending into the settling tank portion; a lamella separator having a spillway within the settling tank portion positioned above the height of the mixing well outlets, wherein the spillway is located within the center of the lamella separator and wherein the lamella separator is configured for operation with the housing up to at least 5% out of level in roll and pitch orientations; and a fluid outlet coupled to the spillway.

These and other aspects and advantages of the present invention will be described below in connection with the associated figures.

### BRIEF DESCRIPTION OF THE FIGURES

FIG. 1 is a schematic perspective (partially exploded) view of a portable settling tank configured for use as a sediment control in accordance with one embodiment of the present invention;

FIG. 2 is a top plan schematic (partially exploded) view of the portable settling tank of FIG. 1;

FIG. 3 is a schematic (partially exploded) left side elevation view of the portable settling tank of FIG. 1;

FIG. 4 is a schematic front end elevation view of the portable settling tank of FIG. 1;

FIG. 5 is a schematic back end elevation view of the portable settling tank of FIG. 1;

FIG. 6 is a schematic sectional side elevation view of the portable settling tank of FIG. 1;

FIG. 7 is a schematic sectional perspective view of the portable settling tank of FIG. 1;

FIG. 8 is a schematic perspective view of a fluid inlet and agitation and distributive piping portion of the portable settling tank of FIG. 1;

FIG. 9 is a schematic front elevation view of the fluid inlet and agitation and distributive piping portion of FIG. 8;

FIG. 10 is a schematic cross sectional perspective view illustrating a mixing well of the portable settling tank of FIG. 1;

FIG. 11 is a schematic cross sectional rear elevation view illustrating the mixing well of the portable settling tank of FIG. 1;

FIG. 12 is a schematic perspective view of the portable settling tank of FIG. 1 with the fluid inlet and agitation and distributive piping portion removed;

FIG. 13 is a schematic perspective view of a lamella separator portion, spillway portion and fluid outlet of the portable settling tank of FIG. 1;

FIG. 14 is a schematic side elevation view of the lamella separator portion, spillway portion and fluid outlet of FIG. 13;

FIG. 15 is a schematic illustration of the operation of the lamella separator portion;

FIG. 16 is a schematic perspective view of the spillway portion and fluid outlet of the portable settling tank of FIG. 1;

FIG. 17 is a schematic perspective view of a continuous sludge removal system of the portable settling tank of FIG. 1;

FIG. 18 is a schematic perspective view of a distributed vacuum manifold of the continuous sludge removal system of the portable settling tank of FIG. 1;

FIG. 19 is a schematic side elevation view of the distributed vacuum manifold of FIG. 18;

FIG. 20 is a schematic perspective view of a portable settling tank configured for use as a sediment control in accordance with a second embodiment of the present invention; and

FIG. 20 is a schematic perspective view of the portable settling tank of FIGURE with the housing removed for clarity.

### DESCRIPTION OF THE PREFERRED EMBODIMENTS

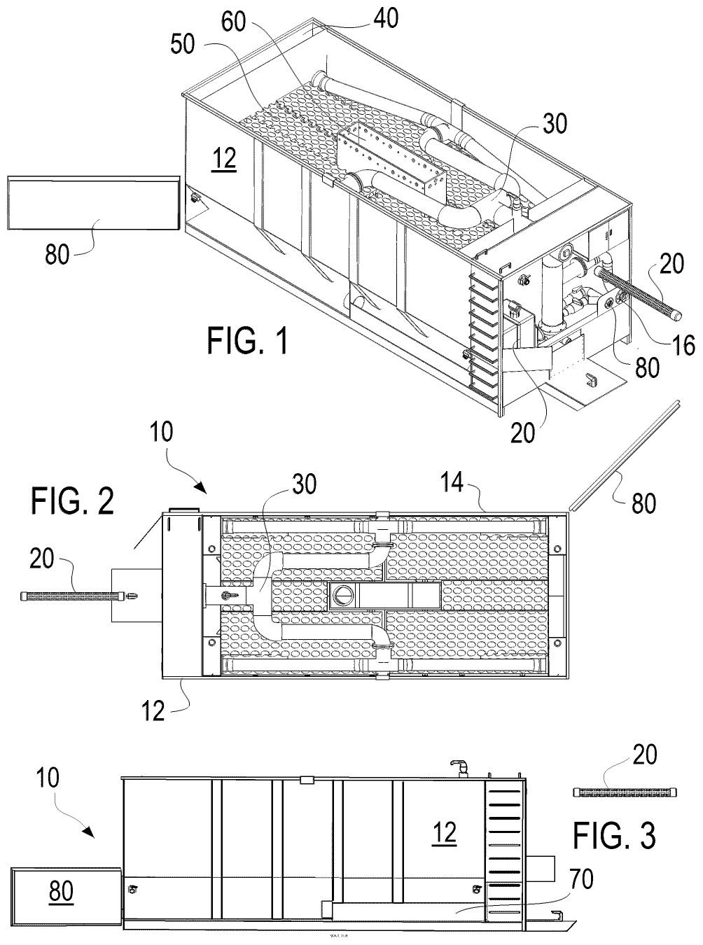

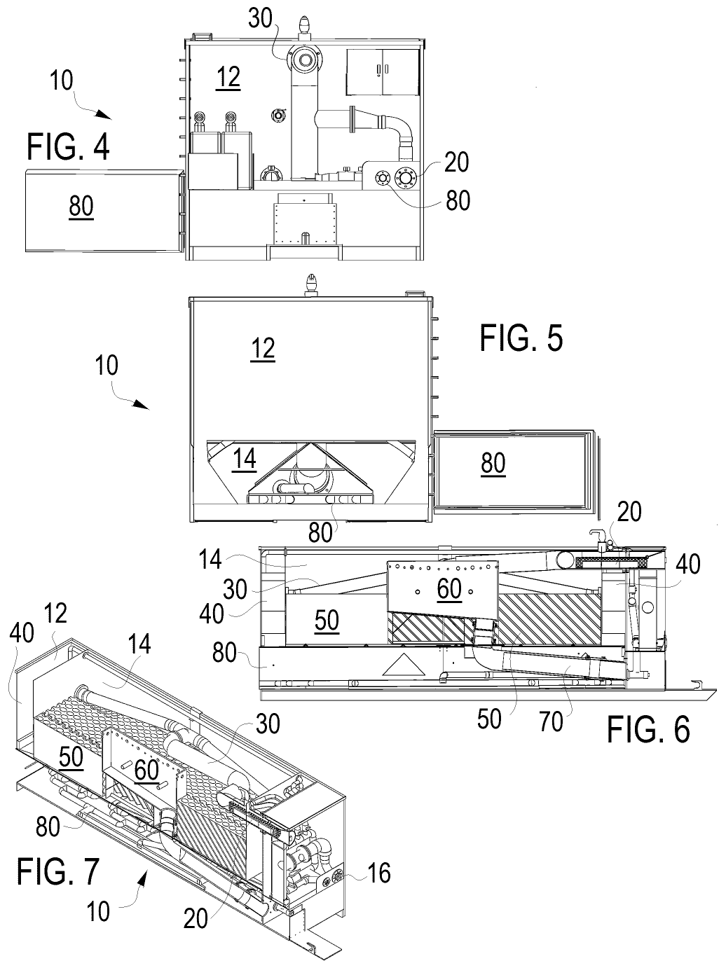

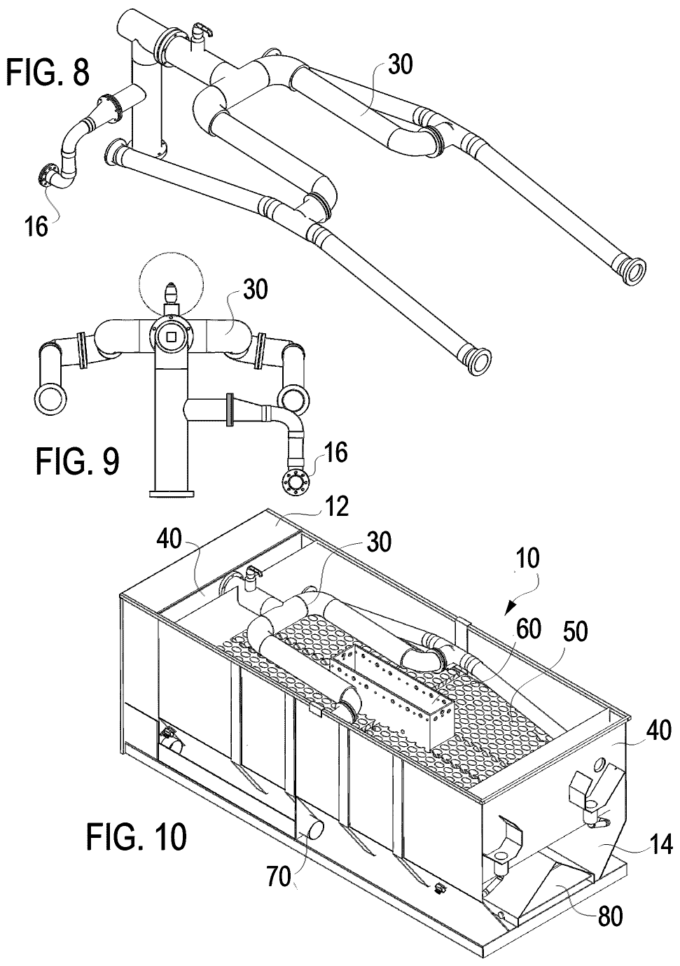

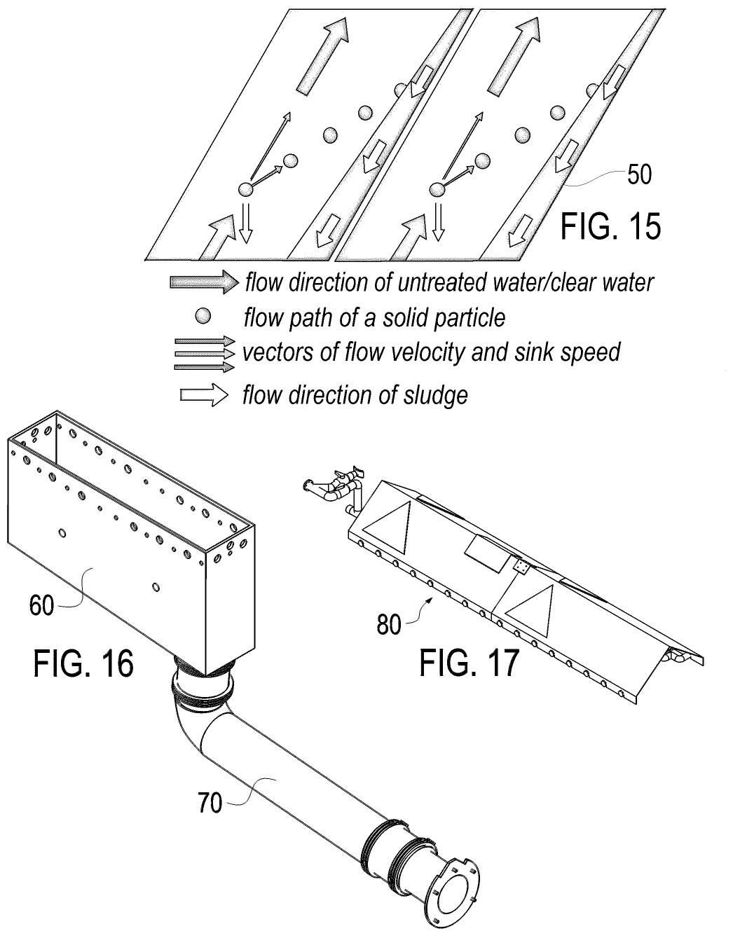

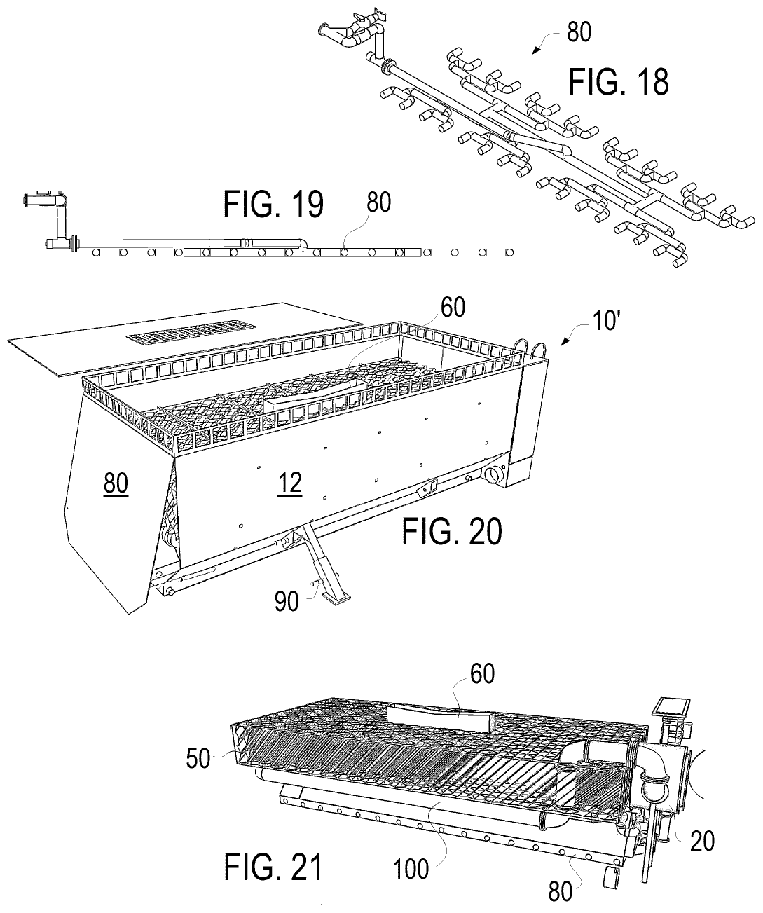

The present invention shown in the attached FIGS. 1-21 may be summarized as a portable lamella settling tank system 10, or sedimentation tank system 10, which is configured for use as a sediment trap. The fluid treated in operation as a sediment trap is water runoff, however the system has broader application as a settling tank, or sedimentation tank, for other fluids. In the description of the system as a sediment trap, water runoff and fluid may be used interchangeably, but this language does not limit the potential applications of the system 10 of the invention, such as a general solids separator that could be used in industries such as wastewater, sewer authorities, municipalities, etc.

The tank system 10 of FIGS. 1-19 includes a transportable or portable housing 12 having a settling tank portion 14; a fluid inlet 16 within the housing 12; a fluid treatment station downstream of the inlet configured for fluid treatment additives to be introduced to incoming fluid; agitation piping 30 downstream of the fluid treatment station configured to mix the fluid treatment additives and the incoming fluid; mixing wells 40 downstream of the agitation piping 30 with outlets extending into the settling tank portion 14; a lamella separator 50 above the height of the mixing well outlets; a spillway 60 located within the center of the lamella separator 50, wherein the lamella separator 50 (and system 10) is configured for operation with the housing up to at least 2% out of level in roll and pitch orientations; a fluid outlet 70 coupled to the spillway 60; and at least one sludge takeout or removal system 80 for removal of sludge.

The removed sludge can be transferred to a conventional sludge box or filter bag that have a much lower gallon per minute treatment rate. The portable lamella settling tank system 10 can remove 80-90% of the water from the sludge quickly with a conventional slow flow operating filter bag or sludge box removing the rest. The water exiting the system 10, or from a downstream filter bag/sludge box, will have low enough turbidity for release into the environment.

Housing 12

The present invention provides the system 10 contained within a transportable or portable housing 12 having a settling tank portion 14 (also called a sedimentation tank). Transportable or portable within this application defines that the housing is configured or portability with conventional transportation modes. Thus a transportable or portable system 10 as defined herein is not typically part of permanent infrastructure at a worksite that would require extensive planning, engineering, permitting, excavating and on-site construction. The portable system 10 within the meaning of the present application can be moved to and from a site via a hitch trailer, flatbed truck, roll-off truck, or similar conventional conveyance and further will not typically require special permitting for road travel. The system 10 of the invention would typically be brought on-site for temporary, or emergency use, and then taken away when not needed. The system 10 is configured to easily move from site to site.

1. Roll-Off Container Housing 12

The preferred method of forming a transportable or portable housing 12 is constructing the housing 12 as a watertight reinforced steel roll-off box, also called a roll-off container. The housing 12 shown is generally about a 20′×8′×6½′ structure with the central 16-18′ longitudinal part of the housing 12 between mixing wells 40 forming the settling tank portion 14. In operation this system 10 will be holding about 4000-5000 gallons at continuous operation and weigh about 45,000 lbs. In view of this operational weight, it may be desired to include external bracing 90 (shown in system 10′ of FIGS. 20-21) may be provided for additional safety as discussed below, however for many or most applications no added bracing will be needed. Further, the sidewalls and end-walls of the housing 12 must be water tight and may include additional support structures such as ribs, also called side stakes.

The system 10 of the present invention, like traditional roll-off containers, is conventionally placed by roll-off trucks, also called container trucks. The housing 12 includes a front lift point and a bottom skid plate. For delivery of the system at a given location the container truck and system 10 drive to a desired location at a site. Then as the roll-off truck raises its hydraulically operated bed, the roll-off container forming the housing 12 of the invention rolls off the bed. A cable coupled to the lift point of the housing 12 is used to slowly lower the housing 12. For removal of the system 10 from the site, the roll-off truck pulls the housing 12 onto the roll-off truck with the cable and winch system operating in the reverse from the drop off.

The orientation of the housing 12 on the truck defines the relative directions of the housing 12. The front end, or fore end or forward end, of the housing 12 is the end near the cab of the truck during transport and contains the lift point or cable coupling for the roll off truck. The back end, aft end or rear end of the housing 12 is the end near the end of the truck during transport. The base or bottom of the housing contains the skids, also called rails, engaging with the elements of the roll off truck for moving the housing onto and off of the roll off truck. Heavy duty rollers could also be provided abut the skid plate without rollers is deemed more stable in location. The longitudinal direction extends from the front to the back of the housing 12 and defines a roll axis relevant for defining the level condition of the system 10 side to side. The pitch axis is perpendicular to the longitudinal axis and parallel to the ends and relevant for defining the level condition of the system 10 front to back.

The housing 12 has an operative footprint of 20′×8′ in plan or top view. As shown the sidewall structures of the settling tank portion 14 are 8′ apart at the upper outer sidewalls which extend down to inwardly sloped portions extending down to a housing base which includes the skid plate. These inwardly sloped portions of the lower sidewalls of the housing 12 forms ½ of the sloped walls for a sludge accumulator as discussed below and provides a recessed space or clearance for mounting of two fluid outlets 70 and optional housing brace 90 mounts and possibly clean out door 80 operational structures that do not increase the overall footprint of the housing 12 in plan view. The recessed location on longitudinal lower housing 12 may further provide storage for accessories like braces or hoses during transportation, however as discussed below this space yields a water trough for a number of ancillary operations.

An access ladder is on the front end of the housing providing operator access to a top (the roof or lid) of the housing 12. The access ladder is not included in the 6½′ height of the housing 12, nor is the skid structure. The total height of the system 10 including these structures is preferably such that when mounted on a conventional roll off truck the total height is less than or equal to 13′ 6″. All states within the United States have legal height restrictions for vehicles on most highways (without permits and exemptions), with 13′ 6″ being the standard in the eastern United States and 14′ being common in western states. The total height of the system 10 when mounted on a conventional container truck is far below these maximums.

Lift points can optionally be placed around the top of the housing 12 in the upper reinforcing structure which may be called the top chord. Lift points present an alternative method of lifting and moving the system 10 for positioning and/or loading onto transport (or for gravity based batch unloading). For example, at a worksite if it is desired to reposition the housing 12 into a new location the lift points may be used, if an appropriate hoisting mechanism is available to safely lift the housing 12, without recalling the container truck to the site. Additionally, the system 10 may be shipped via rail, without an associated container truck, in what is known as a well rail car or container railcar car. This shipping method is analogous to what is known as long haul shipping of tractor trailer containers in container rail cars. Long haul shipping via rail is much more energy efficient and there is no need for a driver for every railcar. The lift points allow the railway a mechanism to easily load and unload the system 10 onto the well railcar for such long-haul shipping.

2. Alternative Housings

The preferred embodiment is a roll-off container housing 12, however other alternatives for the system 10 of the present invention are possible. Building the housing 12 as a towable trailer is also possible. Conceptually this modification is the integration of the housing 12 as shown with the bed of the container truck (which is “separated” from the remainder of the truck in this embodiment) forming a towable trailer. In this modification the hydraulic lift, cable winch and skid/roller base structure is eliminated because the housing is integrated with the bed. The container truck is replaced with any vehicle capable of towing the towable trailer housing of this embodiment of the invention. The above description is intended to explain the structural differences in this modified embodiment and not, of course, defining a method of actually manufacturing this embodiment. The lift points discussed above would be used for gravity-based dumping of the sludge with lifting of the forward end of the housing in this embodiment.

As noted above the preferred embodiment is a roll-off container housing 12 that is well suited for long haul rail shipping in shipping containers. An further alternative housing configuration is to form the housing 12 as the actual body of a railcar that is supported on spaced railcar trucks. An underframe of the housing 12 in this embodiment would include additional components for operation of the system as a railcar. The railcar housing embodiment could be effective where the use locations are positioned along an existing rail line. Such a rail car implementation offers an advantage of minimal pitch out of level positions and almost no out of level roll positions due to track location, but such a system would be captive to the rails. The captive railcar housing configuration is, thus, possible but less practical for many applications.

Fluid Inlet 16

The fluid inlet 16 is at the front of the housing 12 and includes a 3″ or 4″ standard coupling, such as a Bauer type coupling, allowing a flexible hose to be coupled from the supply pump to the system 10. The fluid inlet 16 brings the incoming fluid within the 20′×8′ footprint of the housing 12. The flexible hose may also be stored with the system 10 for transport and storage. The fluid inlet 16 is at the forward end of the housing 12 in what is essentially an open control section of the system 10 in front of the settling tank portion 14 and the mixing wells 40. The fluid inlet 16 is configured to handle more than 1000 gallons per minute, while general standard operation will be at 250-700 gallons per minute. Typical standard operation will be 250-450 gallons per minute while high performance operations will be at 500-750 gallons per minute. As noted the system 10 has components rated to handle greater than 1000 gallons per minute but settling rates for most fluids would not accommodate flows this high. The actual speed of the inflow will depend upon the inflow pump and the operational characteristics desired. The fluid inlet 16 is designed to diffuse the inflow of fluid and the fluid inlet expands in diameter and turns degrees a fluid treatment station 20 downstream of the inlet 16.

In continuous sludge removal mode, at 600 gallons per minute of operation, as detailed below, a diaphragm sludge pump is pulling out about 90 gallons per minute from the bottom of troughs of the settling tank portion 14 of the system 10 and sending the sludge for secondary processing (if desired) such as to a membrane filtering (like in a nonwoven dewatering bag), while 510 gallons per minute are going over the spillway 60 or weir and eventually out of the system 10 via fluid outlet 70. In batch mode, the system operates at 600 gallons per minute of operation until it is needed to be dumped. In either the continuous or the batch mode the system 10 may initially be operated at a higher rate of up to 1,000 gallons per minute for several minutes until the settling tank portion 14 is sufficiently filled and drop to 600 gallons per minute before the water level reaches the spillway 60 and the weir 60 is engaged.

The system 10 can be coupled to any appropriate sized inlet pump, however the SUNBELT brand 4″ diesel automatic priming trach pump essentially represents an ideal inlet pump for the system 10 of the present invention. It is also possible to operate the system 10 with merely head pressure from the source of inlet fluid where the system 10 is located sufficiently below the source of inlet fluid.

The system 10 is designed to allow for gravity to drain the fluid inlet 16 when not under pressure. The self-draining of the fluid inlet 16 is important for four season operation of the system 10. In use of the system 10 in a climate in which the temperature is often below freezing and the system 10 is being shut down (e.g., after a shift/overnight) the self-draining will prevent water remaining in the fluid inlet 10 after system shutdown. Unwanted freezing of significant residual water in the fluid inlet 16 could otherwise prevent or delay starting the system 10 in the morning/start of shift and/or damage the system 10.

Other elements are included in the fluid inlet or may be included if desired. For example, a rock trap is shown that allows and promotes larger particles to dropping out of the flow. The construction of such the rock trap is a turn in the flow with a mesh screen above a rock catching sump whereby the change in direction of the flow and the mesh serve to allow the larger rock particles to drop out of the flow into the sump which will have a separate cleanout access. Most supply pumps will include an incoming screen to protect the pump, and this screening of the incoming fluid generally prevents oversized particles from entering the system 10 such that the rock catch may not always be needed. Further, particulates that can make it into the system 10 can also make it to the settling tank portion 10 and out of the continuous or gravity based sludge removal without damage to the system 10 or its operation. For these reasons the rock trap is generally an optional feature.

Fluid Treatment Stations 20

The system of the present invention includes one or more fluid treatment stations 20, also called an additive introduction systems 20, downstream of the inlet 16 configured for fluid treatment additives to be introduced to incoming fluid. The most common treatment additive for this type of application is flocculating agent. Flocculating agents, also known as flocking agents, flocculants, coagulants, or clarifying agents, are chemicals that promote flocculation by causing colloids and other suspended particles in liquids to aggregate, forming a floc and thus come out of suspension. Polyacrylamide (PAM) is a common flocculating agent for waste water streams and is commonly supplied in pressed blocks that are placed in the inflow of fluid and slowly consumed by the incoming fluid. In water treatment, coagulation flocculation involves the addition of compounds that promote the clumping of fines into larger floc so that they can be more easily separated from the water. Coagulation is a chemical process that involves neutralization of charge whereas flocculation is a physical process and does not involve neutralization of charge. Despite the difference between chemical coagulation and flocculation, coagulants may be viewed herein as a flocculating agent as it is used to assist the settling and flocking process.

One fluid treatment station 20 is a long open mesh tube filled with a dissolvable agent, with the tube of the station 20 fitting within the top central horizontal portion of piping leading to the agitating piping 30. This station 20 is shown pulled from this piping in the partially exploded FIGS. 1-3 and is shown in position in FIG. 7. A second type of fluid treatment station 20 are the liquid injectors shown in the front right of the control portion of the housing. A pilot line (not shown) extends from the fluid treatment stations 20 to a suitable injection site after the inlet 16. The fluid treatment system 20 formed as the fluid injectors require minimal power to operate the injectors and generally have a control to adjust the injection rate.

An alternative fluid treatment system 20 is shown in the embodiments of FIGS. 20-21 which includes a duck billed check valve following the inlet 16. Downstream of the fluid inlet duck billed check valve is a fluid treatment system 20 formed by a chamber that contains a removable water treatment block holding cage into which appropriate treatment blocks, such as those containing flocculants such as PAM. The treated fluid exits the fluid treatment chamber and will pass through a second duck billed check valve as it enters the settling tank portion 14 of the housing 12. The first and second duck billed valves are in a raised position such that water drains away from the valves when not in operation and is an aspect that allows for all season use of this embodiment to prevent residual water from freezing next to the valve when the system 10 is not in use. The first and second check valve serve to isolate the fluid treatment system 20 formed by the chamber to allow for access and changing of the treatment agents. An upper vent pipe with a float valve shut off is provided that allows air to escape the chamber during filling, and air back into the chamber when draining, with the float valve shutting the vent off when the chamber is full.

In normal operation in all embodiments the incoming fluid flows through the fluid inlet 16 to or through the desired fluid treatment system 20. The treated water flows out into the agitation piping 30 discussed below. When the treating agent needs to be changed in the dissolvable agent type systems 20 the incoming pump is stopped and the fluid treatment system will be drained. In the embodiment of FIGS. 1-19 this will occurs without separate check valves due to the positioning of the system 20. In the embodiment of FIGS. 20-21 the two check valves will isolate the chamber and a lower drain is opened to drain the fluid in the chamber to the forward water outlet manifold (discussed below). The float valve may be visible to the operators as an indication that the chamber is full of fluid to remind the operator to drain the chamber before access. A front access door can be opened and the tube or cage containing the treating agent elements or blocks removed and new elements or blocks added. In the embodiment of FIGS. 20-21 the cage rests on pins as shown that are keyed, or spaced, to prevent the cage from being installed in any improper orientation such that the flow over the bricks will always be in a predetermined direction. The front control section of the system includes storage for new fluid treating agents, generally flocculating agents. Chemical treatment companies can form the fluid treating agent blocks in any desired shape; however, the tube or cage versions are designed to accommodate currently commercially available flocculation agent element or block shapes.

Polyacrylamide is not the only flocculation agent and flocking agents are not the sole treatment that may be supplied in the system 10. Chelating agents, PH adjustment, buffers, precipitating agents, disinfectants, may all be practical in a given application. More than one treatment additive may be added simultaneously to the incoming fluid. Essentially any water treatments known in municipal water treatment facilities or treatments used in soil remediation applications could be viable.

Further, blocks of solid treating agents are not the sole water treatment method for the system 10, as the system 10 accept liquid fluid treatment additives with injecting or metering unit. Power for such a liquid metering system can be supplied by battery in forward control section, however as discussed below the system 10 is designed to minimized powered components. The solid treating agent in the form of semisolid element or blocks is preferred as the elements or blocks are known, easy to use and able to supply the desired treatment for the vast majority of system applications.

Agitation Piping 30 and Mixing Well 40 Fluid Treatment Mixing

The system includes agitation piping 30 downstream of the fluid treatment station leading to one of two mixing wells 40 that are configured to mix the fluid treatment additives and the incoming fluid prior to distribution of the treated fluid into the settling tank portion 14. The agitation piping 30 has a length, together with the dwell time in one of the mixing wells 40, sufficient to assure mixing of the fluid treatment additives and the incoming fluid for about 25-30 seconds before distribution of any fluid into the separating tank portion 14.

The agitation piping 30 can further include one or more mixing static pipe mixing elements to improve mixing. Static pipe mixing elements are elements within the pipe, or formed by the pipe, that mix the fluid conveyed there-through without moving elements. One static pipe mixing element is simply a non-linear path of the agitation piping 30 as every bend adds to the mixing within the agitation piping. Additionally, the agitation piping can include one or more “turbulator corners” forming static pipe mixing elements. A turbulator is simply a device configured to turn laminar boundary layer into a turbulent boundary layer. A turbulator corner is a turbulator that also provides a bend to the fluid direction. Another static pipe mixing element is a spiral baffle within a section of the piping. The spiral baffle may be effectively formed by a mixing auger suspended within the piping of the agitation piping 30.

A further static pipe mixing element that may be incorporated into the agitation piping 30 is one or more Tesla valves or Tesla gates. This structure was called by inventor, Nikola Tesla, a valvular conduit, and it is a fixed-geometry passive check valve. It allows a fluid to flow preferentially in one direction, without moving parts. The device is named after Nikola Tesla, who was awarded U.S. Pat. No. 1,329,559 in 1920 for its invention, which patent is incorporated herein by reference. The original patent describes the unit as follows: the interior of the conduit is provided with enlargements, recesses, projections, baffles, or buckets which, while offering virtually no resistance to the passage of the fluid in one direction, other than surface friction, constitute an almost impassable barrier to its flow in the opposite direction.

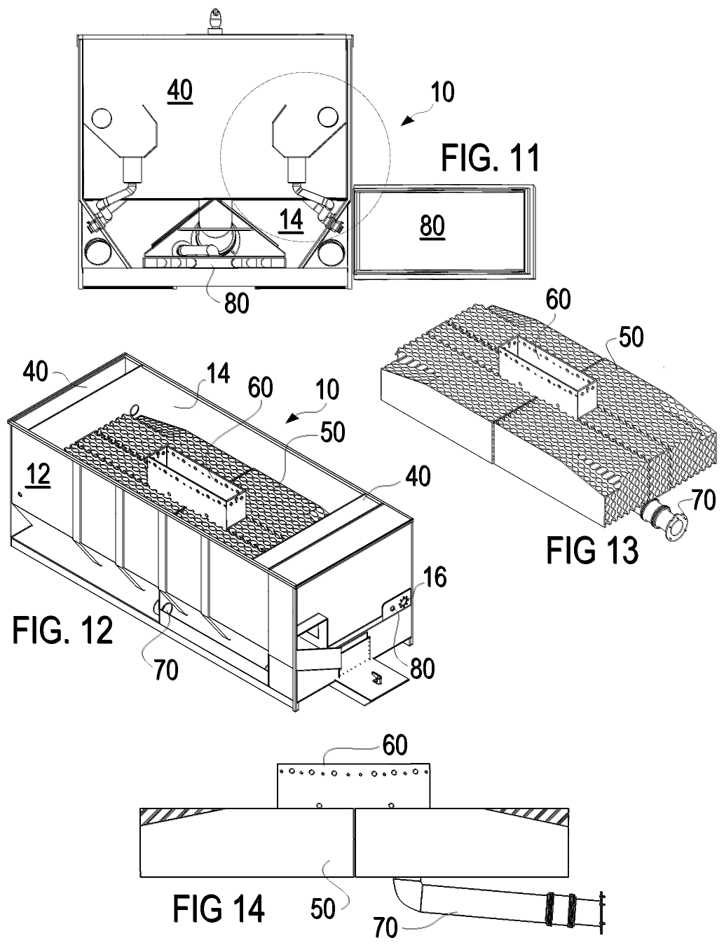

The agitation piping 30 leads to one of two mixing wells 40 on fore and aft sides of the settling tank portion 14. As best shown in FIGS. 10 and 11 the piping leads to upper corners of each mixing well 40 that includes a sand trapping baffle below the inflow from the agitation piping 30. The sand trap baffle will help collect larger particles and there is a separate drain to empty these sand traps when the system is not in use. Each mixing well includes an outlet into the settling tank portion 14 in an area below the lamella separator 50. Essentially the partition wall forming the inner portion of the mixing wells is open at a lower part thereof to allow fluid to flow into the settling tank portion below the area of the lamella separator 50.

The turbulation path within the agitation piping 30 and mixing wells 40 thus has a length, diameter and static pipe mixing elements that keeps the water agitating and turbulation long enough to properly activate conventional treating agents such as the flocculant Anionic Polyacrylamide (PAM) with the system 10 operating at least at its upper operating limits, such as 600 to 750 gallons per minute. The system components are designed to accommodate a flow rate up to at least 1000 gallons per minute and the upper operational limits could approach this amount.

As described above the system 10 includes agitation piping 30 and mixing wells 40 downstream of the fluid treatment station(s) 20, however in certain embodiments it is possible to utilize the agitation piping 30 and mixing wells 40 without use of an integral fluid treatment station Fluid treatment, in some examples, may be added upstream of the system 10, such as in the inlet pump and the system 10 would still yield improvements with the presence of the agitation piping 30 and mixing wells 40.

Lamella Separator 50 and Wier 60

The system 10 includes a lamella separator 50 having a spillway 60 within the settling tank portion 14 positioned above the height of inflow of treated water into the settling tank portion 14 from the mixing wells 40. The lamella separator 50 is configured for operation with the housing 12 up to at least 2% out of level in roll and pitch orientations. Preferably, the lamella separator 50 is configured for operation with the housing 12 up to at least 5% out of level in roll and pitch orientations. More preferably, the lamella separator 50 is configured for operation with the housing 12 up to at least 7% out of level in roll and pitch orientations. The lamella separator 50 shown herein is configured for operation with the housing 12 up to at least 10% out of level in pitch orientation and 15% out of level in the roll orientation.

The measurement of “out of level” is important to clarify for the system 10. In the pitch orientation the out of level is unit of length measurement that one would need to vertically move one end of the housing 12 to be level with the opposite end divided by the total length of the housing 12, about 20 feet. Thus if the rear end of the housing 12 is 1 foot lower than the front then the system 10 is out of level 1 ft/20 ft (×100%) or 5% out of level in the pitch orientation. Similarly, if the rear of the housing 12 is 4.8″ lower than the front then the system is out of level 4.8″/240″ (×100%) or 2% out of level in the pitch orientation. The analogous calculations are done for the roll out of level orientation measurements. For example is the left side of the housing 12 is 9.6″ lower than the right side of the housing 12 then the system 10 is out of level 9.6″/96″ (X100%) or 10% out of level in the roll orientation.

Optimal performance will be reached by placing the housing 12 in a level or close to level orientation namely within 5% of level in both roll and pitch orientations. However, that may not be always be practical on many construction sites. Therefore, the system 10 supports being more out of level in both the pitch and roll orientations. The system 10 can be out of level lengthwise (pitch orientation) by up to about 2-ft (10%) and still perform efficiently, and (simultaneously) the system 10 can be out of level width-wise (roll orientation) up to about 14.4″ (15%) and still perform efficiently. The more out of level in one orientation beyond about 5% (in either or both) the housing 12 is placed, the higher the risk of some sediment escaping through the spillway or weir 60—especially under high GPM flow rates. Out of level in both orientations increases it further. If the housing 12 is out of level by more than 7% in either orientation, it's suggested to run it at a reduced input flow rate, such as up to 350 GPM, to maximize sediment capture.

The lamella separator 50, also called a lamella clarifier, is generically understood to operate to separate settleable solids (particles) from liquids and is widely used for instance in the treatment of process water and waste water. Basically, all solids that sediment in a given time, can be separated easily and economically with the lamella separator 50 the operation of which is schematically shown in FIG. 15. Depending on the density those are usually solids larger than approximately 50 μm in diameter. For separating smaller particles and turbid substances, flocculants are used as noted above in order to create settleable flakes.

In operation, the fluid below the lamella separator 50 streams up through the lamellae. The solids settle down counter-currently on the lamellae.

The clarified water flows further upwards and via a special overflow weir 60, also called a spillway, to the fluid outlet 70. The solids slide down along the lamellae and accumulate in a lower sludge accumulation area of the settling tank portion 14 with sloped sides extending down toward the lower sludge accumulation area.

The present system 10 uses a lamella separator 50 that is formed as a rectangular (in top plan view) array of polygon tubular elements forming lamellae. The number of tubular elements for the lamella separator 50 are selected to assure that the solid settling rate of treated fluid is greater than the operational limits of the device at full continuous mode (say 600 gallons per minute input) in a non-level position. In other words at 10% out of level in the pitch orientation and 15% out of level in the roll orientation and operating at 600 gallons per minute input with a fluid having 5% solid content and adding PAM flocculating agent the rate of settling and flocking of the lamella separator 50 will yield a settling rate (conventionally given in inches or centimeters per minute) of slightly greater than 7 inches per minute which exceeds the water inflow rate for the settling tank portion. Additionally, even at maximum out of level operation the fluid can flow through over 95° of the lamellae.

The tubular elements forming lamellae of the lamella separator 50 are angled relative to vertical to increase the water flow passage. The lamella separator 50 is shown having all the tubular elements angled in the same direction which may simplify construction, however it is anticipated that having the lamella separator 50 split into fore and aft halves with each half forming the tubular elements angled up and toward the adjacent mixing well 40 may improve operation as the greater change of direction of flow from below the lamella separator 50 to up through the lamella separator 50 will facilitate separation efficiencies.

One main advantage of the lamella separator 50 as shown is the large effective settling area caused by the use of inclined plates within each of the lamellae, which improves the operating conditions of the clarifiers in a number of ways. The lamella separator 50 is more compact usually requiring only 65-80% of the area of clarifiers operating without inclined plates. Therefore, as the site footprint constraints are of concern in the system 10 the lamella separator 50 as shown is preferred.

A further advantage of the lamella separator 50 is its distinct absence of mechanical, moving parts. The system 10 therefore requires substantially no energy input except for the influent pump and has a much lower propensity for mechanical failure than other clarifiers. This advantage extends to safety considerations when operating the system 10.

The weir 60 has a plurality of openings of different diameters and at different heights to accommodate the out of level operation. A weir 60 in a system 10 that accommodates out of level positions in both roll and pitch orientations is referenced herein as an RP-Weir 60. The RP-Weir 60 illustrated is a weir centered on the roll and pitch centerlines, meaning the longitudinal centerline (about 10′ from the sides of the housing) and the roll centerline (about 4′ from the side of the housing) of the housing 12 extend through the weir opening.

An alternative but analogous RP-Weir 60 is shown in the embodiment of FIGS. 20-21 which includes a V shape in side elevation view. Preferably the center of V weir shape is located at the intersection of the roll and pitch centerlines. The angle of each “V” side generally defines a maximum out of level in the pitch orientation that the system is designed for effective use. In the maximum out of level position the water level will ride up the sides and onto the lid in the interior of the settling portion during continuous operation.

Further alternative RP-Weir 60 shapes are possible. For example four right angle weirs, one in each corner could be used as an RP-Weir 60 configuration. Alternatively six circular weir openings could be placed in the center of each of six rectangular subsections of the lamella (two Fore, two middle and two aft—three on each side of the longitudinal center line). The centered RP-Weir 60 designs of the illustrated embodiments of the present invention simplifies the outlet structure and maximizes the amount of space for the separator.

The present system 10 may have sufficient settling capacity without the lamella separator 50, and the weir 60 could then be provided without such a lamella separator 50 being present. The lamella separator 50, however, greatly improves the efficiency of the system 10 without significant drawbacks and is a preferred implementation of the system 10. Another advantage of the lamella separator 50 is that it provides support for workers to access the weir 60 for system maintenance or the like. Without the lamella separator 50 access to the upper portions of the weir become more difficult.

Sludge Removal Systems 80

The portable lamella settling tank 10 for use as a portable sediment trap according to the invention includes sludge removal systems (collectively 80) for removal of sludge in the settling tank portion 14 in form of i) a batch mode operation including wherein a clean out door 80 is provided in the housing 12 and ii) a continuous mode operation wherein sludge piping 80 is provided extending from a lower area of the settling tank portion 14. The settling tank portion 14 includes a lower sludge accumulation area with sloped sides extending down toward the lower sludge accumulation area. The sludge accumulation area is essentially two troughs in the lower portion of the housing 12 with sloped sidewalls leading down to the smooth sided troughs.

A first mode of sludge removal, the batch mode, is a clean out door 80 which is provided on a back end of the housing 12 allowing for gravity-based dumping of the sludge with lifting of an opposed front end of the housing 12. The dumping operation will operate as follows, the inflow pump is stopped and the water is allowed to drain out of the settling tank portion 14 above the area of the sludge into the forward water outlet manifold (as discussed below in connection with the fluid outlet 70). With the water drained sufficiently from the settling tank portion 14, the housing 12 may be transported to a separate dumping location. With the water drained sufficiently from the settling tank portion 14 the clean out door 80 may be opened, and slow release pistons may be provided to retard the motion to prevent a dangerous speedy opening due to the weight of the sludge when the door 80 is unlocked. The opposed front or leading end of the housing 12 is lifted via the lift points or via a container truck and the system 10 will dump, via gravity, the sludge from the sludge accumulation area. The door 80 may be closed and the system returned to the site for resuming operation.

The first gravity based sludge removal mode allows for running the system 10 without a sludge pump in lower load situations, say of 350 gallons per minute or less. The settling tank portion 14 of the system 10 is geometrically designed to allow for dumping as the sludge removal (or de-sludging) method as 8-10 cubic yards of sludge can be settled in the bottom of the settling tank portion 14 before it needs dumped. As a representative example, if the system 10 processing 300 gallons per minute at a 2.5° solids load, then about one cubic foot would be settled per minute—or about 2 cubic yards an hour. In this example, processing would need stopped for dumping after about four hours (or switched over to another system 10 unit while the first system 10 is drained and dumped (using a roll off truck and opening the cleanout door 80). The dumping process can be accomplished in less than one hour.

The second mode of sludge removal by the sludge removal system 80 is a continuous mode of operation and is through use of a sludge pump sludge vacuum system shown in detail in FIGS. 17-19. This second mode of sludge removal allows for continuous operation of the system and this is where sludge removal piping (or sludge piping) is provided extending from a lower area of the settling tank portion. The sludge piping is located generally within a lower center sill compartment as shown in FIG. 17 wherein the sludge piping includes a plurality of branched sludge pipes coupled to the troughs forming the sludge accumulation area in the settling tank portion 14. The branched pipes lead to a single sludge outlet which is equidistant along each of the branched sludge pipes to the settling tank portion. The single sludge outlet has a conventional coupling, such as a Bauer coupling for attachment to a sludge pump for removal of the sludge. The equidistant arrangement of the sludge pipes assures an even removal along each trough whereby if one branch pipe is partially blocked the remaining pipes will evenly accommodate the differential.

The second or continuous mode of sludge removal can be referenced as a sludge vacuum system that equally distributes the suction across all ports because the design incorporates a vacuum path length which is the same distance from every input port to the output port where the diaphragm pump, or sludge pump is attached. Evenly distributing this vacuum minimizes the formation of currents and eddies in this portion of the settling tank that could prevent the flocking sediment from fully settling.

The sludge pump is sized to accommodate continuous operation mode for the system and a 90 gallons per minute diaphragm pump is generally suitable for full operation of the system. The sludge pump will deliver the sludge to appropriate location, such as to a dewatering bag for further processing as desired.

The distributed sludge removal piping, when used with a single diaphragm pump operating at 90 GPM creates 60 stops and starts of water flow at 32 distributed locations/ports every 60 seconds. Although each manifold port sucks in just 6 oz of material per second, in the collective (32 ports) it's about 200 oz of material displaced, 6-ft down near the bottom of the sedimentation tank 14 every second. This material displacement at the bottom of the sedimentation tank 14 creates a constant reverberating “Distributed Oscillation” effect. The operation of the 32 suction ports in this manner will send out a small “shock waves” at the speed of sound—about 1100 ft/sec. 12 mini-shock waves will interfere with each other as they bang into each and reverberate off the housing 14 (i.e. a mini shock wave traveling from one port another port just 9 feet away will actually take about 6 milliseconds). The result is a constant even vibration of the sedimentation tank 14 that increases the performance of contact settling.

Fluid Outlet 70

The system 10 includes a fluid outlet 70 coupled to the spillway or weir 60. The fluid outlet 70 generally comprised three components: a conduit coupled to the spillway 60 leading down through the lamella separator 50; a forward water outlet manifold coupled to the conduit in a lower forward portion of the housing, and a pair of side troughs in the recessed lower portions of the housing 12.

The conduit extends through the lamella layer 50 and substantially through the settling tank portion 14 to the forward outlet manifold. Water entering the conduit via the spillway represents clarified water that can exit the system 10.

The forward water outlet manifold is positioned below the open control section. The main function of the forward water outlet manifold is that it receives the clarified water and allows the water to leave the system via two laterally positioned 10″ outlets leading to two longitudinally extending troughs on the lower outer portion of the housing 12.

At a distal end of the troughs are standard coupling for piping to be attached thereto. The clarified water can be directed as desired onsite from these standard coupling outlets. The trough is designed for several potential uses. First, is that it provides a convenient test location for visually inspecting the clarified water as well as testing with instrumentations. Visual inspection or testing equipment can be used to adjust the speed of the system to maximize the desired result (e.g. slow the system if greater clarification is needed, or speed up if the water is more than fine and faster throughput is desired). The second purpose is that it could offer a drinking trough for animals in select applications. A third purpose is that it can be used for secondary water treatment of the clarified water. The space in the trough may be sufficient to add agents such that the system yields clarified and potable water—particularly useful in emergency applications, such as after a flood or hurricane.

The forward water outlet manifold can also selectively receive water in the settling tank portion 14 via a fast drainage bypass operated by a valve in the control section. The fast drainage may be used when the system 10 is intended for faster draining. For example, if the system 10 needs transported quickly the inlet pump may be turned off and the fast drainage valve opened and the settling tank portion 14 will drain in less than ½ hour and the system 10 can be transported and/or dumped.

Braces 90

The system 10 according to the present invention optionally includes vertically adjustable braces 90 shown in FIG. 20, with each brace 90 having a stored position for transport and an engaged position attached to a side of the housing 12. Each brace 90 includes a horizontal extension member that is selectively coupled, via pins, to the housing 12 in select locations and a telescoping vertical leg that can be extended to a select height engaging the ground and pinned into position. The braces 90 provides select lateral bracing to prevent the rollover of the system 10. The braces 90, once deployed is similar to a flying buttress can will stabilize the system 10. The system 10, when operating in continuous mode, can weigh around 45,000 pounds. A construction site typically has large equipment moving about along unmarked pathways and the bracing provided by these elements 90 may be used to help prevent accidental tipping of the system in this often-chaotic environment.

The system 10 may use of two braces 90 that are installed by the operator with placement of the housing 12 in position, preferably as level as practical in the given environment. As noted above it is critical that the present system 10 can accommodate some out of level, even up to 12 degrees or more, but the more level the placement the more efficient the system 10 will operate. After positioning of the housing 12, the user can place the bracing with elements 90 typically on opposed sides of the low fore or aft end. The installation of the bracing provides a mental checking step for the operator to check the degree of level. In this manner the operator can check to make sure the degree of level is within the operational parameters. Further the vertical adjustment may be set such that the first engaged position is generally at the roll level of the operational limits such that the bracing generally could not be installed or deployed if the roll angle is too far out of level for operational effectiveness, offering a separate check on the operator.

Roof

The system 10′ of FIGS. 20-21 includes a roof, or lid, with an open grate covered center. The open center allows air to move into and out of the system 10 prevent a vacuum from forming and effecting the system 10 efficiency. The open center roof also allows for evaporation to also act on the water within the tank 14. Outer edges of the inside of the roof will be engaged with the upper level of the water when operating at the outer extremes of the operating parameters, preventing the need for the sidewalls and end walls of the housing 12 to be extended further passed the lamella separator 50 in this embodiment. The grated center prevents larger animals from falling into the tank portion 14 of the system 10. The roof can include an outer railing that will yield or define some vertical storage space on the top of the system for tools, or hoses in transport, and the railing may further hold or incorporate easily accessible lift points at designated locations. The lift points must be able to accommodate the full weight of the full system 10 and the lid may further include visible indicators of the lift point locations.

Sensors

The system 10 of the present invention can be fully monitored. Water quality sensors, such as NTU sensors (also called turbidity sensors, nephelometer, or turbidimeter), PH sensors, temperature sensors, salt concentrations sensors, heavy metal sensors could be used and the results uploaded to the cloud for real-time recording and access of the results of the system 10. The outflow sensor can be placed in the in the fluid outlet 70 as discussed above and communicate with a transmitter within the control section powered by a rechargeable battery. The rechargeable battery may be powered by a solar panel on the roof. The system 10 can also monitor the quality of the sludge and the inflow with desired sensors; however, it is likely that the clarified outlet fluid will be of primary interest.

Distribution Manifold 100

The embodiment of FIGS. 20-21 has another significant difference in that it replaces the agitation piping 30 and mixing wells 40 with a below the lamellar separator 50 positioned distribution manifold 100 which provides about 75-ft long turbulation path below the separator 50. The volume within the manifold 100 is approx. 250 gallons. Thus at 500 gallons per minute input, a given unit of water will be in the manifold for 30 seconds before it moves into the settling tank portion 14 through a plurality of distributed outlets extending into the settling tank portion. The distribution manifold 100 has four eight-inch openings or outlets facing downward in the settling tank portion 14. In a level arrangement all the ports will distribute flow evenly. This configuration is designed to accommodate out of level arrangements. When out of level in the pitch and/or roll orientations the lowest of the four ports will have an increased flow while the highest port will still have some flow still allowing for adequate fluid distribution within the settling tank portion 14. Portions of the manifold 100 includes 1 inch diameter weep holes along the length thereof that serve dual purposes. The first purpose is that a small amount of the fluid in the manifold 100 (less than 15° volume maximum) is directed into the settling tank portion 14 and supports settling of the sludge from the fluid in a process that is sometimes references as “flocculation with sludge contact”. When the system 10 is operating at pressure (water is being pumped in) then the weep holes in the agitation piping forces or jets water into the sedimentation tank or settling tank portion 14. This “jetting” is effects “contact settling” or sludge recirculation (known as flocculation with sludge contact), a technique that has been proven to enhance and continue flocculation in the sedimentation tank 14. Additionally, when the system 10 is not in use the weep holes allow the system 10 to drain and not allow residual water to remain in locations in which it may freeze and limit the use of the system 10 or cause damage thereto.

Cold Weather Design

The system 10 is designed specifically for use in any climate including a climate in which the temperature is often below freezing and the system is being shut down (e.g., after a shift/overnight). Cold weather shut down procedures are common in construction equipment, for example if the wet mud is not addressed in the tracks of certain equipment at the end of the day the operators may come in in the morning and find the tracks frozen and the machine inoperable. The system 10 of the present invention is designed to allow for a shutdown procedure in which self-draining will prevent water remaining in any critical areas after system 10 shutdown. Unwanted freezing of significant residual water in the select system components could prevent or delay starting the system in the morning/start of shift and/or damage the system 10.

The shutdown procedure begins with the shutting off of the inflow pump and decoupling the line from the fluid inlet. The sludge pump is shut off and disconnected. Drain valves are opened to allow excess water to drain. The clean out door is opened again allowing excess water to drain. The system 10 can be easily and quickly prepared for cessation of operation in cold weather. This shut down procedure is not required where there is no danger of freezing and the system 10.

Operation

The present system 10 provides an advanced 250-750 gallons per minute portable sediment trap device when operating in conventional continuous or batch modes. Optimal performance of the device in conventional continuous mode can be achieved with the device 6-inches or less out of level in both directions (pitch and roll), an inlet pump operating at 450-750 gallons per minute, a flocculating agent such as PAM is being used, and 90 gpm diaphragm sludge pump is being used (such as a Wacker Neuson PDT 3, PDT 3A, or PDI 3A). The diameters and opening sizes along the water flow path are designed to support up to 1,000 gallons per minute of hydraulic flow, but conventional continuous operation mode is set at 450-750, generally 600, gallons per minute. The system 10 can operate in continuous (sludge pump) or batch (dump when full) mode at a desired continuous inflow and weir outflow as described above.

In the embodiment of FIGS. 20-21, there is an alternative mode called a single tank batch mode, in which the settling tank portion 14 is filled and the inlet stopped before the weir 60 is engaged and the system allowed to sit as it slowly drains via the triangular longitudinal manifold weep holes are configured such that they will drain the full settling tank over an 8-16-hour period, preferably a 12-hour period. The single tank batch mode may yield a higher efficiency in particulate removal due to an increased dwell time of water in the tank portion 14 and may be preferred for small capacity jobs, particular where dumping is to be accomplished offsite.

This system 10 was designed because of the realization that portable sediment trap systems cannot effectively continuously filter suspended solids from effluent in runoff. For robust continuous operation the portable sediment trap system 10 of the present invention is designed to floc and settle at relatively high rates. The portable sediment trap system 10 of the invention has been designed to be portable, robust, high flow, simple to use, and accept that level is not always available. Further to better comply with the modern technology age and regulatory requirements, the present invention is able to report and store to the cloud in real time on the quality of the water output (and any other parameters desired to be tracked). The design the system 10 of the present invention eliminates or greatly minimizes moving pieces within the settling tank portion 14 of the system 10 and there is no required external power supply for the settling operation. In continuous mode, the only external forces are the brown/grey pump pumping fluid in and the sludge pump pumping sludge out. Manual valves are minimally used for some drainage functions. The sensor and communication system operates with minimal power supplied by a rechargeable battery and onboard solar panel. Additionally, the system 10 does not utilize or rely upon filters. These design features allow the system 10 to work on constructions sites where there is no guarantee a power source would be reliably available, and greatly improves the reliability of the system 10 minimizing elements that can malfunction, wear out, or break while generally reducing the cost of manufacture and operation of the system.

The following potential applications can highlight the advantages of the system 10 of the present invention. If a construction site is having problems meeting the limits of a post-construction NPDES Permit, the system 10 of the present invention could be used to treat stormwater before it goes into the public waters. The pH, heavy metals, TSS, and other aspects of the water quality could be treated when running the water through the system 10 of the present invention. While excavating or dredging a large body of water, the system 10 of the present invention could be used in conjunction with turbidity curtains to clean the water within the curtain area. In small dredging situations, the system 10 of the present invention could be used to floc and settle before pumping a much lower volume slurry to dewatering bags. Further the system 10 of the present invention may be implemented in temporary, or even permanent, deployment to treat and remove solids in a combo storm/sanitary situation. When doing a stream crossing or cofferdam work, sediment laden water can be pumped to the system 10 of the present invention for flocking and settling. The system 10 also may be effectively employed for department of transportation applications near a bridge or on a road where sediment will be introduced into water but where there is no room to build a sediment trap.

The present invention is designed as a portable sediment trap, but may have application more broadly as a portable settling tank system 10. The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A sedimentation tank
a portable housing having a settling tank portion;
a fluid inlet within the housing;
a sludge removal system for removal of sludge in the settling tank portion including sludge piping extending from a lower area of the settling tank portion, and wherein the sludge piping includes a plurality of branched sludge pipes coupled to the settling tank portion and leading to a single sludge outlet, and wherein the single sludge outlet is equidistant along each of the branched sludge pipes to the settling tank portion.

2. The sedimentation tank according to claim 1, further including a weir within the settling tank portion configured for settling operations when the housing is level in the pitch and roll orientations or an out-of-level pitch and roll orientation of up to 10% in the pitch orientation or up to 15% in the roll orientation; and a fluid outlet coupled to the weir.

3. The sedimentation tank according to claim 1, further including a lamella separator having a spillway within the settling tank portion positioned below and cooperating with the weir, and further including a vacuum pump coupled to the sludge outlet.

4. The sedimentation tank according to claim 1, further including a fluid treatment station downstream of the inlet configured for fluid treatment additives to be introduced to the incoming fluid prior to entry of the fluid into the separation tank portion.

5. The sedimentation tank according to claim 4, further including agitation piping downstream of the fluid treatment station leading to mixing wells and configured to mix the fluid treatment additives and the incoming fluid prior to entry of the fluid into settling tank portion.

6. The sedimentation tank according to claim 1, wherein the sludge removal system for removal of sludge in the settling tank portion further includes a clean out door in the housing.

7. The sedimentation tank according to claim 6, and further including a vacuum pump coupled to the sludge outlet and wherein the tank is configured for operation in at least one batch mode using the clean out door for sludge removal and in at least one continuous mode using the sludge piping for sludge removal.

8. A Sedimentation Tank comprising:
a portable housing having a settling tank portion;
a fluid inlet within the housing;
a weir within the settling tank portion configured for settling operations when the housing is level in the pitch and roll orientations or an out-of-level pitch and roll orientation of up to 10% in the pitch orientation or up to 15% in the roll orientation; and
A fluid outlet coupled to the weir.

9. The sedimentation tank according to claim 8, further including a lamella separator having a spillway within the settling tank portion positioned below and cooperating with the weir.

10. The sedimentation tank according to claim 9, wherein the lamella separator is formed as an array of tubes.

11. The sedimentation tank according to claim 8, further including a fluid treatment station downstream of the inlet configured for fluid treatment additives to be introduced to the incoming fluid prior to entry of the fluid into the separation tank portion.

12. The sedimentation tank according to claim 11, further including agitation piping downstream of the fluid treatment station leading to mixing wells and configured to mix the fluid treatment additives and the incoming fluid prior to entry of the fluid into settling tank portion.

13. The sedimentation tank according to claim 12, wherein the agitation piping includes at least one static pipe mixing elements including at least one of Telsa gates, spiral baffling or turbulation corners.

14. The sedimentation tank according to claim 8, further including at least one vertically adjustable brace attached to a side of the housing.

15. A portable lamella sediment trap comprising:
a transportable housing having a settling tank portion;
a fluid inlet within the housing from which fluid can be directed to the settling tank portion;
a lamella separator having a spillway within the settling tank portion positioned above the height of where fluid enters the settling tank portion, wherein the lamella separator is configured for operation with the housing up to at least 2% out of level in roll and pitch orientations; and
a fluid outlet coupled to the spillway.

16. The portable lamella sediment trap according to claim 15, wherein the spillway is located within the center of the lamella separator and the lamella separator is configured for operation with the housing up to at least 10% out of level in roll and pitch orientations.

17. The portable lamella sediment trap according to claim 15, further including a sludge removal system for removal of sludge in the settling tank portion including i) a clean out door in the housing and ii) sludge piping extending from a lower area of the settling tank portion; and a fluid outlet coupled to the settling tank portion, wherein the tank is configured for operation in at least one batch mode using the clean out door for sludge removal and in at least one continuous mode using the sludge piping for sludge removal.

18. The portable lamella sediment trap according to claim 17, wherein the settling tank portion includes a lower sludge accumulation area with sloped sides extending down toward the lower sludge accumulation area, and wherein a clean out door is provided on an end of the housing allowing for gravity-based dumping of the sludge with lifting of an opposed end of the housing.

19. The portable lamella sediment trap according to claim 15, further including a sludge removal system for removal of sludge in the settling tank portion including sludge piping extending from a lower area of the settling tank portion, and wherein the sludge piping includes a plurality of branched sludge pipes coupled to the settling tank portion and leading to a single sludge outlet, and wherein the single sludge outlet is equidistant along each of the branched sludge pipes to the settling tank portion.

20. The portable lamella sediment trap according to claim 15, further including a fluid treatment station downstream of the inlet configured for fluid treatment additives to be introduced to the incoming fluid prior to entry of the fluid into the settling tank portion, and further including agitation piping downstream of the fluid treatment station configured to mix the fluid treatment additives and the incoming fluid prior to entry of the fluid into the settling tank portion.
